(19) United States
(12) Patent Application Publication
(10) Pub. No.: US 2024/0367490 A1
(43) Pub. Date: Nov. 7, 2024

(54) PANE ARRANGEMENT

(71) Applicant: Webasto SE, Stockdorf (DE)

(72) Inventor: Georg ROSSMAIR, Stockdorf (DE)

(21) Appl. No.: 18/651,074

(22) Filed: Apr. 30, 2024

(30) Foreign Application Priority Data
May 2, 2023 (DE) 102023111262.7

(51) Int. Cl. B60J 1/00

(52) U.S. Cl. CPC B60J 1/001

(57) ABSTRACT

A pane arrangement for a vehicle which has a first pane element which extends in a first vehicle direction and has a first edge and an opposing second edge in the first vehicle direction. The pane arrangement also has a second pane element which extends in the first vehicle direction, wherein the first pane element and the second pane element surround a pane intermediate space and have a first spacing from one another in a first region of the first edge, have a second spacing from one another in a second region of the second edge and have a third spacing from one another in a first central region which is arranged between the first region and the second region in the first vehicle direction. The third spacing is larger than the first spacing and/or than the second spacing.

### CROSS-REFERENCE TO RELATED APPLICATION(S)

This application claims the benefit of German patent application no. 10 2023 111 262.7 filed on May 2, 2023, which is incorporated herein by reference in its entirety.

### TECHNICAL FIELD

A pane arrangement for a vehicle is specified. A vehicle which has such a pane arrangement is also specified.

### BACKGROUND

Vehicles can be provided with vehicle openings which are closed by pane arrangements. The pane arrangement, for example, is a roof pane, a front pane and/or a rear pane and can be tinted, transparent and/or translucent. Light can pass into the interior of the vehicle through such a pane arrangement. The pane arrangement can also be planar or curved in a vehicle longitudinal direction and/or in a vehicle transverse direction.

It is desirable to create a pane arrangement for a vehicle which permits a reliable operation and which, when installed, provides advantages for the occupants seated in the vehicle interior. It is also desirable to specify a vehicle which permits a reliable operation.

According to one aspect, a pane arrangement for a vehicle is specified. The pane arrangement has a first pane element which extends in a first vehicle direction. The first pane element has a first edge and a second edge which is located opposite the first edge in the first vehicle direction. The pane arrangement also has a second pane element which extends in the first vehicle direction. The first pane element and the second pane element surround a pane intermediate space and have a first spacing from one another in a first region of the first edge and have a second spacing from one another in a second region of the second edge. The two pane elements have a third spacing from one another in a first central region which is arranged between the first region and the second region in the first vehicle direction, wherein the third spacing is larger than the first spacing and/or than the second spacing in, for example, an asymmetrical construction.

A spacing between the two pane elements is defined as the length of the vertical distance from the first pane element to the second pane element. The vertical distance is relative to the first pane element and thus is perpendicular to at least the first pane element and extends in the direction of the second pane element. The vertical distance is not necessarily perpendicular to the second pane element. This is only the case when the two pane elements are oriented parallel to one another. Then the vertical distance is perpendicular to the main surfaces of the two pane elements facing one another. For example, the two pane elements can be oriented parallel to one another in the first and/or second region of the edges of the first pane element. This permits a particularly advantageous coupling of the two pane elements in the region of the edges, since no particular geometry of the orientation of both pane elements to one another has to be considered. According to the invention, it is provided that a spacing of the first pane element from the second pane element perpendicular to the main surface thereof is larger in a central region than the spacing thereof in a first and/or second region of the edges.

The first pane element, which can also be denoted as an inner pane, serves for the thermal and acoustic decoupling of the outer roof surface part relative to the interior of the vehicle. By using an additional pane element, more installation space is required. In order to utilize the installation space in an optimal manner, the spacings are selected to be smaller in the region of the two edges than in the central region. This has the advantage that a sufficiently large spacing is ensured in the central region in order to prevent the two pane elements from colliding with one another when shocks of the vehicle or vibrations of the pane elements occur. Shocks can be produced, for example, when driving over a pothole. Vibrations are frequently due to the construction and are virtually impossible to prevent retrospectively. At the same time, the spacing in the region of the edges is reduced in order to save installation space. A further advantage is that, in addition to the small spacing in the region of the edges, a larger spacing can be achieved in the central region which improves the thermal insulation. Thus with very small spacings of below 1 mm to 2 mm, for example, the thermal insulation becomes relevant again due to thermal conduction. The specified choice of the spacings relates to a pane arrangement before the initial operation of the vehicle and thus to an operation at, for example, room temperatures and normal atmospheric pressures of the environment. The spacing between the pane elements changes after the initial operation of the vehicle due to the different temperatures in summer and winter or a lower pressure in mountainous regions. A cavity which permits a low thermal conduction and thus improved thermal insulation is also formed by the third spacing between the first and second pane element. Moreover, the different spacings can contribute to the stability of the pane arrangement by a targeted absorption of forces.

The first and/or second pane element can be a single pane arrangement, for example toughened safety glass (TSG) or a multipaned arrangement, for example a laminated glass pane such as laminated safety glass (VSG). The first and/or second pane element is preferably produced from glass material but can also be produced from plastics material.

When the pane arrangement is arranged on a vehicle roof, the first pane element is located closer to the passenger compartment in comparison with the second pane element and thus is the internal pane element.

It is also possible to provide further pane elements which are arranged toward the passenger compartment and/or between the pane elements.

### SUMMARY

A further advantage relative to pane elements which have spacings of the same size at each position in the first vehicle direction is the smaller volume in the pane intermediate space. As a result, due to the extent of the enclosed air volume the pane elements are forced apart to a lesser degree, in particular in the central region. In the region of the edges, the pane elements can barely move apart since they are fixedly assembled to the vehicle body shell and are connected to one another in the region of the edges. Correspondingly, for example in the event of a thermal volume expansion, the greatest movement of the pane elements takes place in the central region. The smaller the volume is selected to be in the pane intermediate space, the smaller the movement of the pane elements in the event of a volume expansion.

The different spacings between the pane elements in the first vehicle direction are produced during the manufacture of the pane elements, and not after the manufacture of the pane arrangement due to external influences, such as for example higher temperatures or lower external pressures caused by a pressure difference between the manufacturing site and operating location. The pane elements are intentionally produced with different spacings.

According to one embodiment, the first pane element has a first curvature in the first vehicle direction. The second pane element has a second curvature in the first vehicle direction. The first curvature of the first pane element is smaller than the second curvature of the second pane element. This is to be understood to mean that the first and/or second curvature describe a first or a second curvature path which are fixed by the respective two-dimensional extent of the first or second pane element. The first and/or second curvature path can be continuous or can change. In one embodiment, the definition of the first and second curvature is a central curvature path of the first or the second pane element, for example fixed by the respective edges of the individual pane elements. Preferably, the curvature is such that the curvature path is uneven, in particular that the first and/or the second pane element are not configured as a flat pane.

Preferably, the first pane element is configured such that it has a curvature path which is oriented toward the second pane element. Thus the first pane element is curved toward the second pane element. As a result, a vehicle passenger obtains greater headroom in a vehicle for which the pane arrangement is intended.

The curvatures of the pane elements are produced during the manufacture of the pane elements, and not after the manufacture of the pane arrangement due to external influences, such as for example higher temperatures or lower external pressures caused by a pressure difference between the manufacturing site and operating location. The pane elements are intentionally produced with different curvatures. The curvatures can change due to environmental influences, such as for example air pressure, for example external pressure, and/or temperature, but the first and second pane element themselves have a curvature in each case. In particular, it can be provided that during the production process the first and second pane element are configured such that in operational use, i.e. after assembly on a vehicle opening, the second pane element curves outwardly away from the first pane element. For example, this is produced by a pressure difference between the pressure in the pane intermediate space and the air pressure surrounding the pane arrangement. Thus the third spacing is increased. This brings about a lower heat transition of the pane arrangement in the region of the third spacing.

The different curvatures of the two pane elements make it possible to implement in a simple manner different spacings of the pane elements in various regions. In this manner, it is also possible to design the regions to be flatter at the edges than in the case of pane elements which are arranged in parallel, for example. The different curvatures also serve for the stability of the pane arrangement.

Alternatively, the curvature of the two pane elements can be of the same size during the production of the individual pane elements and the spacing in the first central region is adapted during the final manufacture of the pane arrangement by a greater internal pressure in the pane intermediate space such that the curvature of the first pane element is reduced and is less than the curvature of the second pane element.

According to one embodiment, in the first vehicle direction the second pane element has a first protruding region which protrudes over the first edge of the first pane element and/or a second protruding region which protrudes over the second edge of the first pane element.

The two pane elements do not have to have exactly the same length. This is simpler to implement in terms of manufacturing technology since the manufacturing tolerances are consequently higher.

Alternatively, in the assembled state the pane elements can have the same length in the first vehicle direction. To this end, before assembly, the second pane element has to be longer than the first pane element in the first vehicle direction.

According to a further aspect, the first pane element extends in a second vehicle direction. The first pane element has a third edge and a fourth edge which is located opposite the third edge in the second vehicle direction. The second pane element extends in the second vehicle direction. The first pane element and the second pane element have a fourth spacing from one another in a third region of the third edge and have a fifth spacing from one another in a fourth region of the fourth edge. The two pane elements have a sixth spacing from one another in a second central region which is arranged in the second vehicle direction between the third region and the fourth region, wherein the sixth spacing is larger than the fourth spacing and/or the fifth spacing.

The first vehicle direction can be a longitudinal direction of the vehicle, i.e. a vehicle in which the pane arrangement is intended to be arranged. The pane arrangement is accordingly configured so that a longitudinal direction is correspondingly defined. Alternatively, the first vehicle direction can be a direction of the vehicle which is oriented transversely, in particular perpendicularly to the longitudinal direction of the vehicle. The second vehicle direction can be correspondingly defined.

The pane arrangement can also have different spacings between the pane elements in the second vehicle direction. This can be implemented as an alternative to the first vehicle direction, or additionally combined in both vehicle directions. Further installation space can be saved by the combination of the different spacings in both vehicle directions.

Moreover, the efficiency of a thermal insulation is increased relative to conventional vehicle panes by a lower heat transition due to the air layer formed between the first and second pane element. The effects of the thermal and atmospheric expansion of the volume in the pane intermediate space are even further reduced thereby. Moreover, it is possible to select the fourth and fifth spacing such that the fourth and/or the fifth spacing are larger than the third spacing. The first and/or the second spacing can also be selected to be larger than the sixth spacing in order to obtain more flexibility during the manufacture of the pane arrangement. Thus it is possible to produce in a targeted manner regions which have a specific spacing between the pane elements.

The different spacings between the pane elements in the second vehicle direction are produced during the manufacture of the pane elements, and not after the manufacture of the pane arrangement due to external influences, such as for example higher temperatures or lower external pressures caused by a pressure difference between the manufacturing site and operating location. The pane elements are intentionally produced with different spacings.

According to one embodiment, the first pane element has a third curvature in the second vehicle direction. The second pane element has a fourth curvature in the second vehicle direction. The third curvature of the first pane element is smaller than the fourth curvature of the second pane element.

The different curvatures of the two pane elements in the two vehicle directions make it possible to implement in a simple manner different spacings of the pane elements from one another in various regions. The two pane elements can have in each case different degrees of curvature in both vehicle directions as long as the two curvatures of the first pane element in each case are smaller than the corresponding curvatures of the second pane element. Thus the first curvature of the first pane element does not necessarily have to be smaller than the fourth curvature of the second pane element, for example. The third curvature of the first pane element does not necessarily have to be smaller than the second curvature of the second pane element.

The curvature in the second vehicle direction can be implemented as an alternative to the curvature in the first vehicle direction or additionally combined in both vehicle directions. Even more installation space can be saved by the combination of the different curvatures in both vehicle directions.

According to one embodiment, in the second vehicle direction the second pane element has a third protruding region which protrudes over the third edge of the first pane element and a fourth protruding region which protrudes over the fourth edge of the first pane element.

Similarly, according to one embodiment it is provided that the first pane element in the first and/or second vehicle direction has a first further protruding region which protrudes over a corresponding edge of the second pane element. The first further protruding region is preferably configured on an edge of the first pane element. Preferably, relative to the corresponding edge of the second pane element, this edge forms a first protruding region which preferably extends entirely along this edge. Correspondingly, the first pane element can have a second further protruding region which is configured in a similar manner to the first further protruding region, wherein the second further protruding region is configured on an edge of the first pane element which opposes the first further protruding region.

The protruding regions of the first pane element permit higher structural tolerances when producing and installing the pane arrangement. Alternatively, in the assembled state the pane elements can have the same length in the second vehicle direction. To this end, before assembly, the second pane element has to be longer than the first pane element in the second vehicle direction. A combination of the protruding regions in both vehicle directions is possible. Alternatively, the first pane element can have protruding regions in only one vehicle direction.

According to one embodiment, a spacer is arranged between the two pane elements on at least one of the regions of the four edges of the first pane element and the two pane elements are coupled together by means of the spacer.

Spacers are, for example, an edge composite made of aluminium with drying agents and adhesive which is encapsulated with polyurethane. Alternatively, the spacer can also consist of plastics which is configured directly with a drying agent and also encapsulated with polyurethane foam. The spacer runs around the first pane element along the four edges. This type of spacer provides a simple solution for spacing apart the pane elements.

According to one embodiment, the main surfaces of the first and second pane element extend at least along one edge plane-parallel to one another, so that at least the main surfaces of the first and second pane element, which are oriented toward one another, are oriented plane-parallel to one another in some portions in the region of the edge. Preferably, a plurality of regions of the main surfaces of the first and second pane element, in particular a plurality of edges, are oriented plane-parallel to one another at least in the region of the respective edge. This permits the use of spacers which are produced in a simple manner. The spacing of the first and second pane element in this region can also be designed to be as small as possible so that only a thin connecting layer is sufficient for the fixing and a preferably gas-tight connection of the first pane element to the second pane element. An adhesive bead made of polyurethane and/or an adhesive film made of a polymer, for example polyvinyl butyral (PVB), can be provided as the thin connecting layer.

A spacer can be arranged partially and simply locally, i.e. at predefined local positions and/or arranged along an edge or a region of an edge.

According to one embodiment, an adhesive surface is arranged between the two pane elements on at least one of the regions of the four edges of the first pane element and the two pane elements are coupled together by means of the adhesive surface.

In one embodiment, it is provided that spacers and adhesive are arranged alternately, in particular symmetrically alternately.

The adhesive surfaces make it possible to couple together the two pane elements virtually without spacings. Thus the spacing on the edges can be even further reduced by means of the adhesive surfaces, which leads to a further reduction in the volume inside the pane intermediate space. The direct adhesive bonding is also more advantageous than, for example, using interposed elements. Adhesive surfaces are implemented, for example, by applied adhesive. The adhesive surfaces also form a substantially diffusion-tight connection of the two pane elements which prevent the penetration of condensed gases, such as for example water vapor.

According to one embodiment, the first spacing and the second spacing are of the same size between the two pane elements.

For a particularly symmetrical pane arrangement, the spacings are selected to be of the same size in the region of the edges.

According to one embodiment, the first spacing and the second spacing are of different sizes between the two pane elements.

The choice of different spacings on the first and second edge also makes it possible to provide asymmetrical pane arrangements which fulfil specific purposes of use. A further advantage is that it is possible to compensate for manufacturing tolerances.

According to one embodiment, the fourth spacing and the fifth spacing are of the same size between the two pane elements.

It is also possible to select all four spacings on all four edges to be of the same size.

According to one embodiment, the fourth spacing and the fifth spacing are of different sizes between the two pane elements.

According to a further aspect, a vehicle is disclosed. The vehicle has a vehicle opening and a pane arrangement which is fixed in the vehicle opening according to one of the above-described embodiments. The vehicle substantially permits the above advantages and functions.

The pane arrangement is a front pane, for example. Alternatively or additionally, the arrangement is a roof pane, for example. Alternatively or additionally the arrangement is a rear pane, for example.

The vehicle is a motor vehicle, for example. The vehicle can be a passenger motor vehicle or utility vehicle, for example. Public means of transport, such as buses or trains, are also encompassed.

### BRIEF DESCRIPTION OF DRAWINGS

Further advantages, features and developments are found in the following examples which are described in connection with the figures. Pane elements which are the same, similar and have the same function can be provided in all of the figures with the same reference signs.

In the figures:

FIG. 1 shows a schematic view of a vehicle with a vehicle roof,

FIG. 2 shows a schematic sectional view of a pane arrangement according to an exemplary embodiment,

FIG. 3 shows a further schematic sectional view of the pane arrangement according to an exemplary embodiment,

FIG. 4 shows a further schematic sectional view of the pane arrangement according to an exemplary embodiment,

FIG. 5 shows a plan view of the pane arrangement according to an exemplary embodiment.

### DETAILED DESCRIPTION

In this description, terms such as “top”, “bottom”, “inner”, “outer”, “front” and “rear” and “central” refer to directions and orientations as are illustrated in the figures and are usual in a motor vehicle which is ready for operation.

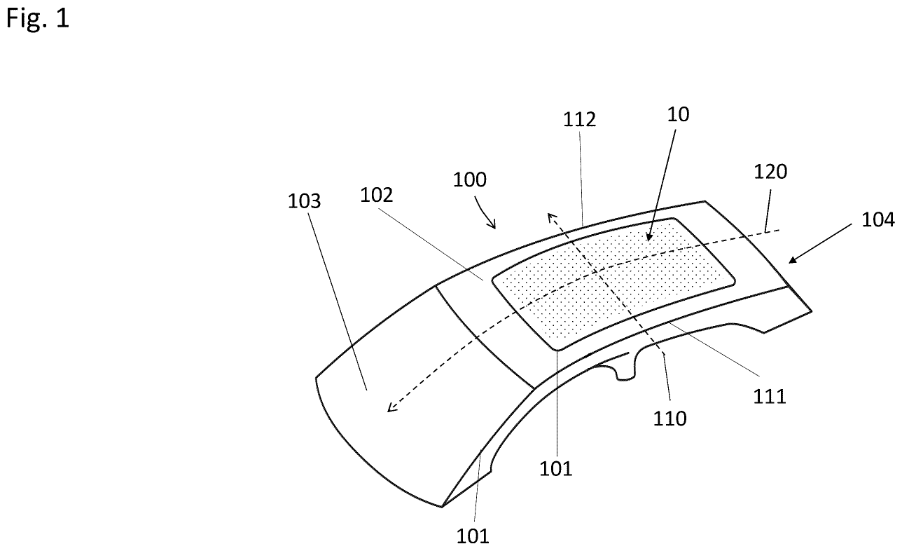

FIG. 1 shows a schematic view of a vehicle 100 which has at least one vehicle opening 101, a vehicle roof 102, a front pane 103 and a rear pane 104. The vehicle 100, for example, is a passenger motor vehicle. The vehicle roof 102 has a pane arrangement 10 which is inserted into the vehicle opening 101 of the vehicle roof 102 and which is fixedly connected to the vehicle body shell, in particular the vehicle roof 102. The pane arrangement can alternatively be configured as a front pane 103 and/or as a rear pane 104 and inserted into the corresponding vehicle opening 101. The vehicle 100 has a first vehicle direction 110 which extends from a first longitudinal side 111 of the vehicle 100 to a second longitudinal side 112 of the vehicle 100 opposing the first longitudinal side 111. The vehicle 100 also has a second vehicle direction 120 which extends from the rear pane 104 of the vehicle 100 to the front pane 103 of the vehicle 100.

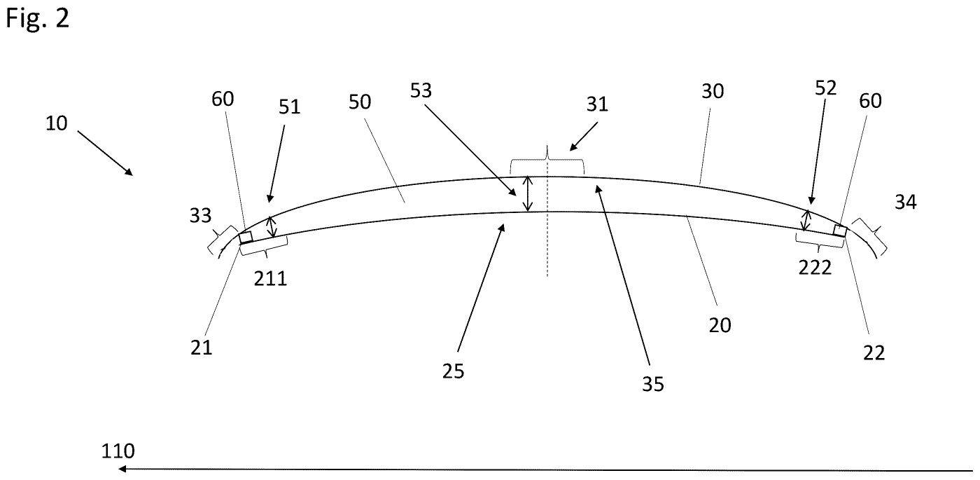

FIG. 2 shows an exemplary embodiment of the pane arrangement 10 in a schematic sectional view. The pane arrangement 10 has a first pane element 20 which extends in the first vehicle direction 110. The first pane element faces the interior of the vehicle 100 in the ready-for-operation state. The first pane element 20 has a first edge 21 in a first region 211. In the first vehicle direction 110, a second edge 22 is located in a second region 222 on the side opposing the first edge 21.

The pane arrangement 10 also has a second pane element 30 which also extends in the first vehicle direction 110. The second pane element 30 faces outwardly and faces away from the interior of the vehicle 100 in the ready-for-operation state. The second pane element 30 has a first central region 31 which is arranged in the first vehicle direction 110 between the first edge 21 and the second edge 22. Moreover, the second pane element has a first protruding region 33 which protrudes over the first edge 21 of the first pane element 20 and a second protruding region 34 which protrudes over the second edge 22 of the first pane element 20.

The two pane elements 20, 30 are arranged spaced apart from one another in the first vehicle direction 110 and together form a pane intermediate space 50. Moreover, the two pane elements 20, 30 are not arranged parallel to one another in the first vehicle direction 110 but have different spacings in the first vehicle direction 110. In the first region 211 the two pane elements 20, 30 have a first spacing 51 from one another, in the second region 222 a second spacing 52 and in the first central region 31 a third spacing 53. The third spacing 53 in the first central region 31 is selected such that it is larger than the first spacing 51 in the first region 211 and than the second spacing 52 in the second region 222. In this manner, installation space can be saved in the region of the edges 21, 22 due to a relatively low structural height. A large headroom is provided for a passenger. Moreover, the volume enclosed in the pane intermediate space 50 is reduced in comparison with a spacing selected to be constant in the first vehicle direction 110. The spacings 51, 52, 53 can be selected such that the first pane element 20 extends in the same direction as the first vehicle direction 110. The first spacing 51 and the second spacing 52 can be selected to be of the same size in order to obtain a particularly advantageous symmetry. Alternatively, the first spacing 51 can be larger than the second spacing 52 or the first spacing 51 can be smaller than the second spacing 52. Due to the differently sized first and second spacings 51, 52, it is possible to compensate retrospectively for structural tolerances. Spacers 60 can be arranged in the first and second region 211, 222 of the edges 21, 22 between the two pane elements 20, 30, so that the two pane elements 20, 30 are coupled to one another via the spacers 60.

The first pane element 20 also has a first curvature 25 in the first vehicle direction 110 and the second pane element 30 has a second curvature 35 in the first vehicle direction 110. The first curvature 25 of the first pane element 20 is smaller than the second curvature 35 of the second pane element 30. The first curvature 25 of the first pane element 20 can also be selected such that the first pane element 20 extends in the same direction as the first vehicle direction 110. The first pane element 20 can thus have a first curvature 21 of zero.

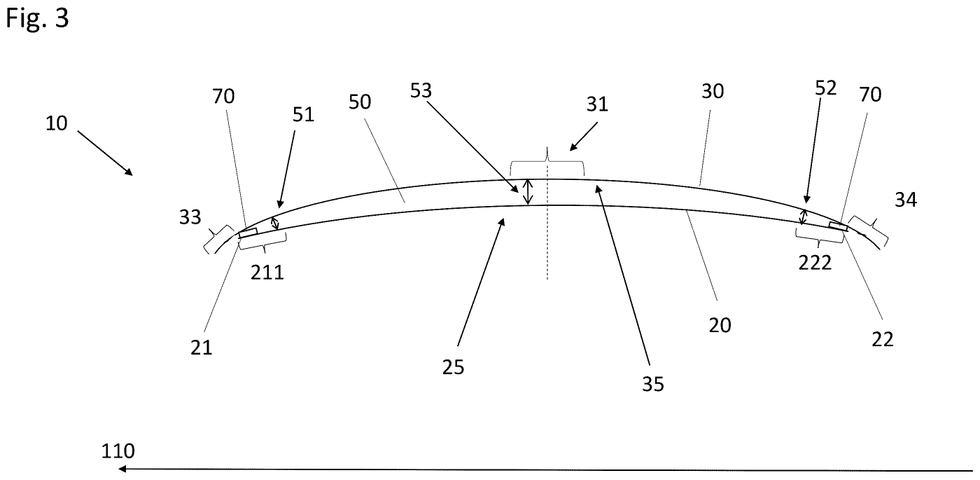

FIG. 3 shows a further exemplary embodiment of the pane arrangement 10 in a schematic sectional view. The pane arrangement 10 shown in FIG. 3 corresponds substantially to the pane arrangement 10 of FIG. 2 with the difference that no spacers 60 are used, but rather adhesive surfaces 70. This has the advantage that even smaller spacings 51, 52 can be implemented in the edge region 211, 222, whereby additional installation space is saved.

Alternatively, a combination of spacers 60 and adhesive surfaces 70 is possible. The spacers 60 and adhesive surfaces 70, for example, can alternate and be applied at equidistant spacings in order to achieve a particularly high degree of symmetry. Alternatively, depending on requirements, the spacers 60 and the adhesive surfaces 70 can be used in order to form specific points which are as narrow as possible in the region of the edges with the adhesive surfaces 70.

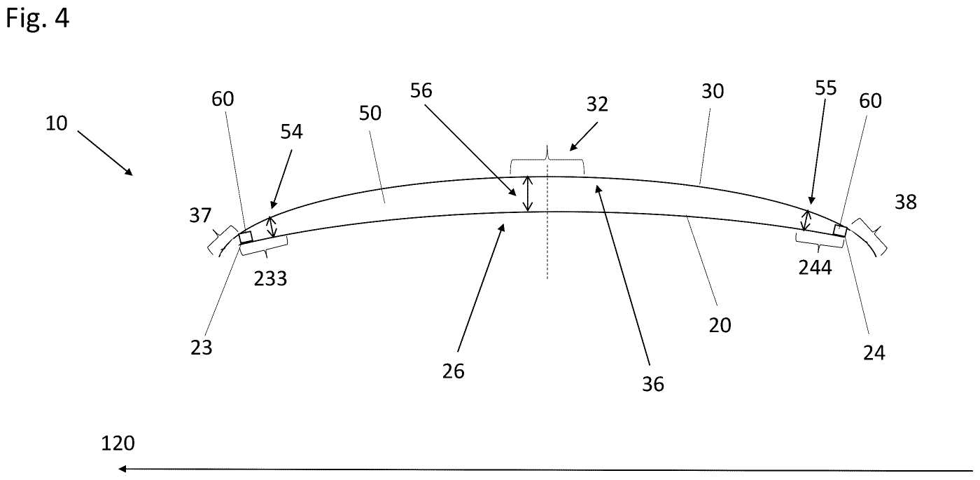

FIG. 4 shows a further exemplary embodiment of the pane arrangement 10 in a schematic sectional view. The exemplary embodiment corresponds substantially to the exemplary embodiment of FIG. 2 with the difference that the first pane element 20 and the second pane element 30 have different spacings in a second vehicle direction 120 and are curved in the second vehicle direction 120.

The first pane element 20 has a third edge 23 in a third region 233. In the first vehicle direction 120, a fourth edge 24 is located in a fourth region 244 on the side opposing the third edge 23.

The second pane element 30 has a second central region 32 which is arranged in the first vehicle direction 110 between the third edge 23 and the fourth edge 24. Moreover, the second pane element has a third protruding region 37 which protrudes over the third edge 23 of the first pane element 20 and a fourth protruding region 38 which protrudes over the fourth edge 24 of the first pane element 20.

The two pane elements 20, 30 are arranged spaced apart from one another in the second vehicle direction 120 and together form the pane intermediate space 50. Moreover, in the second vehicle direction 120 the two pane elements 20, 30 are not arranged parallel to one another but have different spacings in the second vehicle direction 120. In the third region 233 the two pane elements 20, 30 have a fourth spacing 54 from one another, in the fourth region 244 a fifth spacing 55 and in the second central region 32 a sixth spacing 56. The sixth spacing 56 in the second central region 34 is selected such that it is larger than the fourth spacing 54 in the third region 233 and the fifth spacing 55 in the fourth region 244. In this manner, installation space can be saved due to a relatively low constructional height in the region of the edges 23, 24. Moreover, the volume enclosed in the pane intermediate space 50 is reduced in comparison with a spacing selected to be constant in the second vehicle direction 120. The spacings 54, 55, 56 can be selected such that the first pane element 20 extends in the same direction as the second vehicle direction 120. The fourth spacing 54 and the fifth spacing 55 can be selected to be of the same size in order to obtain a particularly advantageous symmetry. Alternatively, the fourth spacing 54 can be larger than the fifth spacing 55 or the fourth spacing 54 can be smaller than the fifth spacing 55. It is possible to compensate retrospectively for potential structural tolerances by the differently sized fourth and fifth spacings 54, 55. At least one spacer 60 is arranged in the third and fourth region 233, 244 of the third and fourth edge 23, 24 between the two pane elements 20, 30 so that the two pane elements 20, 30 are coupled together via the at least one spacer 60. In this exemplary embodiment, instead of the at least one spacer 60 alternatively at least one adhesive surface 70 (not shown in FIG. 4) can also be used. A combination of spacer 60 and adhesive surface 70 (not shown in FIG. 4) is also conceivable. The spacer and adhesive surface can be arranged, for example, alternately. The different spacings 54, 55, 56 can be implemented as an alternative to the different spacings 51, 52, 53 in the first vehicle direction 110 or additionally combined in both vehicle directions 110, 120. Even more installation space can be saved by the combination of the different spacings 51, 52, 53, 54, 55, 56 in both vehicle directions 110, 120. Moreover, the volume in the pane intermediate space 50 is further reduced, which leads to an improved pane arrangement 10.

The first pane element 20 also has a third curvature 26 in the second vehicle direction 120 and the second pane element 30 has a fourth curvature 36 in the second vehicle direction 110. The third curvature 26 of the first pane element 20 is smaller than the fourth curvature 36 of the second pane element 30. The third curvature 26 of the first pane element 20 can also be selected such that the first pane element 20 extends in the same direction as the second vehicle direction 120. The first pane element 20 can thus have a third curvature 21 of zero. The curvatures 26, 36 of the two pane elements 20, 30 in the second vehicle direction 120 can be implemented as an alternative to the curvatures 25, 35 in the first vehicle direction 110 or additionally combined in both vehicle directions 110, 120. Even more installation space can be saved by the combination of the different curvatures 25, 26, 35, 36 of the two pane elements 20, 30 in both vehicle directions 110, 120.

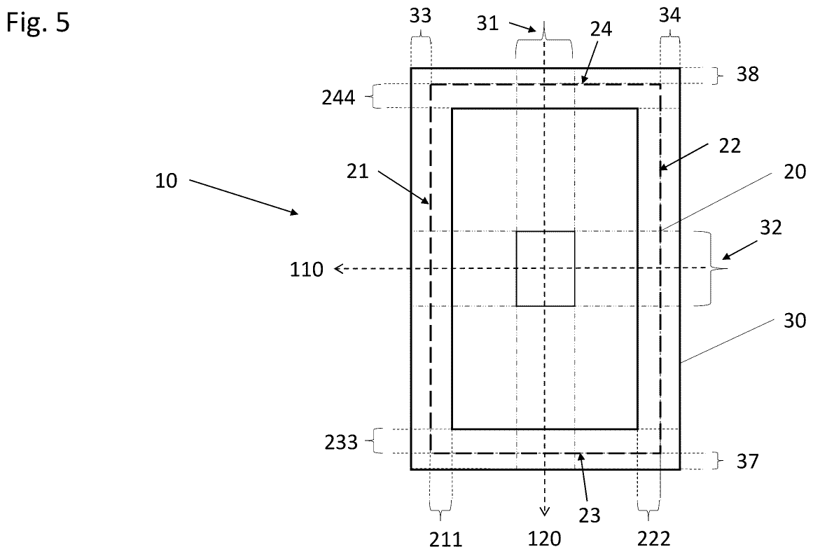

FIG. 5 shows a further exemplary embodiment of the pane arrangement 10 in a plan view. The exemplary embodiment illustrates that a combination of the differently selected curvatures and spacings between the pane elements 20, 30 is possible in the two vehicle directions 110, 120. The two pane elements 20, 30 extend in the two vehicle directions 110, 120, wherein the first pane element 20 is shown with a dashed line in order to illustrate that it is located below the second pane element 30.

The second pane element 30 has the protruding regions 33, 34, 37, 38 which in each case protrude over the edges 21, 22, 23, 24 of the first pane element 20. The protruding regions 33, 34, 37, 38 can be selected to be of different sizes. The four edges 21, 22, 23, 24 are located in each case in the corresponding regions 211, 222, 233, 244 in which the spacings between the two pane elements 20, 30 are smaller than the spacings in the respective central regions 31, 32 in the respective vehicle direction 110, 120.

The two pane elements 20, 30 can have in each case different degrees of curvature in both vehicle directions 110, 120, as long as the two curvatures of the first pane element 20 in each case are smaller than the corresponding curvatures of the second pane element 30.

### LIST OF REFERENCE SIGNS

10 Pane arrangement
20 First pane element
21 First edge
211 First region
22 Second edge
222 Second region
23 Third edge
233 Third region
24 Fourth edge
244 Fourth region
25 First curvature
26 Third curvature
30 Second pane element
31 First central region
32 Second central region
33 First protruding region
34 Second protruding region
35 Second curvature
36 Fourth curvature
37 Third protruding region
38 Fourth protruding region
50 Pane intermediate space
51 First spacing
52 Second spacing
53 Third spacing
54 Fourth spacing
55 Fifth spacing
56 Sixth spacing
60 Spacer
70 Adhesive surfaces
100 Vehicle
101 Vehicle opening
102 Vehicle roof
103 Front pane
104 Rear pane
110 First vehicle direction
120 Second vehicle direction

1. A pane arrangement for a vehicle, having
a first pane element which
extends in a first vehicle direction and
has a first edge and an opposing second edge in the first vehicle direction,
a second pane element which
extends in the first vehicle direction, wherein
the first pane element and the second pane element surround a pane intermediate space and
have a first spacing from one another in a first region of the first edge,
have a second spacing from one another in a second region of the second edge and
have a third spacing from one another in a first central region which is arranged between the first region and the second region in the first vehicle direction, wherein
the third spacing is larger than the first spacing and/or than the second spacing.

2. The pane arrangement according to claim 1, wherein
the first pane element has a first curvature in the first vehicle direction and
the second pane element has a second curvature in the first vehicle direction, wherein
the first curvature of the first pane element is smaller than the second curvature of the second pane element.

3. The pane arrangement according to claim 1, wherein in the first vehicle direction the second pane element
has a first protruding region which protrudes over the first edge of the first pane element and/or
has a second protruding region which protrudes over the second edge of the first pane element.

4. The pane arrangement according to claim 1, wherein
the first pane element
extends in a second vehicle direction and
has a third edge and an opposing fourth edge in the second vehicle direction, and
the second pane element
extends in the second vehicle direction, wherein
the first pane element and the second pane element
have a fourth spacing from one another in a third region of the third edge,
have a fifth spacing from one another in a fourth region of the fourth edge and
have a sixth spacing from one another in a second central region which is arranged in the second vehicle direction between the third region and the fourth region, wherein
the sixth spacing is larger than the fourth spacing and/or than the fifth spacing.

5. The pane arrangement according to claim 4, wherein
the first pane element has a third curvature in the second vehicle direction and
the second pane element has a fourth curvature in the second vehicle direction, wherein
the third curvature of the first pane element is smaller than the fourth curvature of the second pane element.

6. The pane arrangement according to claim 4, wherein in the second vehicle direction the second pane element
has a third protruding region which protrudes over the third edge of the first pane element and/or
has a fourth protruding region which protrudes over the fourth edge of the first pane element.

7. The pane arrangement according to claim 1, wherein a spacer is arranged between the two pane elements on at least one of the regions of the edges of the first pane element and the two pane elements are coupled together by the spacer.

8. The pane arrangement according to claim 1, wherein an adhesive surface is arranged between the two pane elements on at least one of the regions of the edges of the first pane element and the two pane elements are coupled together by the adhesive surface.

9. The pane arrangement according to claim 1, wherein the first spacing and the second spacing are of the same size between the two pane elements.

10. The pane arrangement according to claim 1, wherein the first spacing and the second spacing are of different sizes between the two pane elements.

11. The pane arrangement according to claim 4, wherein the fourth spacing and the fifth spacing are of the same size.

12. The pane arrangement according to claim 4, wherein the fourth spacing and the fifth spacing are of different sizes.

13. A vehicle, having a vehicle opening and a pane arrangement which is fixed in the vehicle opening according to claim 1.
